(19) United States
(12) Patent Application Publication
(10) Pub. No.: US 2016/0025002 A1
(43) Pub. Date: Jan. 28, 2016

(54) IMPROVED OPPOSED PISTON ENGINE

(71) Applicant: TWO STROKE DEVELOPMENTS LIMITED, Middlesex (GB)

(72) Inventor: Paul Ellis, Greater London (GB)

(21) Appl. No.: 14/774,400

(22) PCT Filed: Mar. 12, 2014
(86) PCT No.: PCT/GB2014/050741

§ 371 Date: Sep. 10, 2015

(30) Foreign Application Priority Data
Mar. 12, 2013 (GB) 1304458.1

(51) Int. Cl. F02B 75/28; F01L 1/04; F01L 5/20; F02B 9/02; F01L 5/04

(52) U.S. Cl. CPC F02B 75/282; F02B 9/02; F01L 5/04; F01L 5/20; F01L 1/04

(57) ABSTRACT

The invention relates to an opposed piston engine comprising at least one cylinder, at least two pistons arranged to be reciprocated within the same cylinder in an opposed manner, at least one intake port through the cylinder wall, at least one exhaust port through the cylinder wall, at least one shaft arranged to be rotated by reciprocal motion of the opposed pistons, at least one reciprocatable sleeve valve within the cylinder for controlling porting of one or both of the at least one intake port and the at least one exhaust port, a sleeve valve driving mechanism for controlling reciprocal motion of the at least one sleeve valve, and a dwell mechanism. The dwell mechanism is configured to induce at least one period of dwell of the at least two pistons during their respective cycles of piston motion.

### FIELD OF THE INVENTION

This invention relates to an internal combustion engine of the type in which a pair of opposed pistons is arranged to reciprocate within the same cylinder.

The invention is particularly suited to an internal combustion engine operating a two-stroke cycle. It is also particularly suited to a two-stroke compression ignition engine.

### BACKGROUND TO THE PRESENT INVENTION

Published UK patent application number GB2477272 and published international patent application number WO2011/092501 disclose an engine having a pair of pistons linked by a linking element which reciprocate within cylinders formed in a rotating cylinder block. As the pistons reciprocate within the cylinders, followers attached to the pistons cause the cylinder block to rotate around cams formed on a fixed central camshaft. The rotating cylinder block rotates within a fixed outer casing and is coupled to a further shaft for power take-off. A reciprocating sleeve valve is provided for each piston for covering and uncovering ports through which air enters the cylinders and as the cylinder block rotates, the sleeves are reciprocated by further cams.

The piston cams are shaped so as to cause a period of dwell of the pistons so that substantially all of the heat exchange of combustion occurs at constant volume. Intake ports in an end of the rotating block are alignable on rotation of the block with an intake port in the fixed casing to allow air into the casing. A transfer channel/passage leads from the intake ports in the rotating block to transfer/scavenging ports in the cylinder walls. An exhaust port is provided in the fixed casing so as to allow the waste products of combustion to pass from the end of the cylinders when they are aligned with the exhaust port on rotation of the cylinder block. In operation of the engine, the sleeve valve is used to cover and uncover the transfer/scavenging ports in the cylinder walls. The intake and exhaust ports are covered and uncovered by rotation of the cylinder block relative to the fixed casing.

This engine has a number of benefits over other types of known engines. However, the inventor has appreciated that there are a number of challenges to effective operation of this engine, including:
effective lubrication of the rotating block rotating within the fixed outer housing to minimise frictional losses;
effective sealing of the rotating block as it rotates within the fixed outer housing;
efficient scavenging of the air due to the length of the transfer passages leading from the intake ports in the rotary block to the transfer/scavenging ports in the walls of the cylinder;
effective balancing of the engine due to the combination of forces resulting from reciprocation of the pistons and sleeves in a rotating cylinder block;
the precise machining tolerances required between the rotating cylinder block and the outer housing; and
the need to protect the cylinders against high lateral loads exerted by the pistons on the walls of the cylinders so as to rotate the block around the fixed shaft.

Prior art engines include opposed piston engines comprising a linear reciprocating sleeve valve or an oscillating rotary sleeve valve. Examples of such engines include UK patent number GB158532 to Hult, U.S. Pat. No. 5,623,894 to Clarke and UK patent number GB497300 to Porkman.

Prior art engines also include opposed piston engines comprising means for providing a period of dwell of the pistons. Examples of such engines include UK patent number GB377614 to Kriedler and UK patent number GB442126 to Alfaro.

The present invention seeks to provide an engine capable of more efficient operation through improved volumetric efficiency. It also seeks to provide an engine which has reduced emissions, for example soot, compared to prior art engines. It also seeks to address other challenges associated with prior art engines.

### SUMMARY OF THE INVENTION

In the following description the term “transverse centreline” is used to refer to a line through the centre of the engine which is orthogonal to the rotational axis of the shaft and which extends horizontally through the centre of the combustion space defined between the piston crowns of the opposed pistons in each cylinder when in their Top Dead Centre (TDC) positions.

In the following description, the term “inner” is intended to mean being positioned closer to the transverse centreline of the engine and the term “outer” is intended to mean being positioned further from the transverse centreline of the engine.

In the following description, the term “dwell” is used to refer to a period of rotation of the shaft during which the pistons remain stationary. “Dwell” is intended to refer to a period of stationary motion which is longer than the instantaneous moment at which reciprocating pistons in a conventional internal combustion engine (in which one or more pistons connected to conrods rotate a crankshaft) are stationary at their Top Dead Centre (TDC) and Bottom Dead Centre (BDC) positions.

The present invention provides: an opposed piston engine comprising: at least one cylinder; at least two pistons arranged to be reciprocated within the same cylinder in an opposed manner; at least one intake port through the cylinder wall; at least one exhaust port through the cylinder wall; at least one shaft arranged to be rotated by reciprocal motion of the opposed pistons; at least one linear reciprocatable sleeve valve positioned within the cylinder and surrounding at least one of the at least two pistons; a sleeve valve driving mechanism for controlling linear reciprocal motion of the at least one sleeve valve so as to control porting of one or both of the at least one intake port and the at least one exhaust port; and a dwell mechanism; wherein the dwell mechanism is configured to induce at least one period of dwell of the at least two pistons during their respective cycles of piston motion.

The opposed piston engine of the invention is believed to have a number of advantages over known engines, including some or all of the following:—

(i) inherent balancing of the engine;

(ii) increased volumetric efficiency resulting from a greater period of the engine cycle during which the intake ports are open to allow air to enter the cylinder, a greater period of the engine cycle during which the exhaust ports are open to allow scavenging of the cylinder; and a greater period of the engine cycle during which the intake and exhaust ports are open leading to improved airflow through the cylinders;

(iii) reduced soot formation due to an increase in the time available for combustion of fuel in the cylinder at constant volume;

(iv) reduced or eliminated side loads on the cylinder walls;

(v) ability to provide more ‘normal’/standard engine tolerances between moving components;

(vi) simpler lubrication and sealing between moving components.

Some preferred features of the invention are set out in the dependent claims and discussed below.

Preferably, the at least two pistons are arranged to be reciprocated linearly and coaxially. More preferably, the at least two pistons are arranged to be reciprocated between respective TDC positions in which the piston crowns are substantially adjacent one another and respective BDC positions in which the piston crowns are spaced from one another. More preferably, the at least two pistons are arranged to be reciprocated in a synchronous manner.

Preferably, the timing of porting events during the engine cycle is controllable independently of the position of the pair of opposed pistons within the cylinder.

Preferably, reciprocal motion of the at least one sleeve valve controlled by the sleeve valve driving mechanism is linked to the reciprocal motion of the at least two pistons. More preferably, the sleeve valve driving mechanism is arranged to reciprocate the at least one sleeve valve out of phase with the reciprocal motion of the at least two pistons.

Preferably, the dwell mechanism is configured to induce a period of dwell of the pistons at their respective BDC positions during the cycle of piston motion. More preferably, the period of dwell of the pistons at their respective BDC positions is sufficient for the majority of the scavenging of the waste products of combustion through the at least one exhaust port to occur before the pistons begin to move away from their respective BDC positions.

Preferably, the dwell mechanism is configured to induce a period of dwell of the pistons at their respective BDC positions of between 60 and 140 degrees of rotation of the at least one shaft, more preferably, about 100 degrees of rotation of the at least one shaft.

Preferably, the dwell mechanism is configured to induce a period of dwell of the pistons at their respective TDC positions during the cycle of reciprocal piston motion. More preferably, the period of the pistons at their respective TDC positions is sufficient for substantially all of the heat exchange of combustion to take place in the cylinder at constant volume before the pistons begin to move away from their respective TDC positions. More preferably, the dwell mechanism is configured to induce a period of dwell of the pistons at their respective TDC positions of between 20 and 60 degrees of rotation of the at least one shaft, more preferably about 40 degrees of rotation of the at least one shaft.

Preferably the dwell mechanism is a cam mechanism. More preferably, the piston cam mechanism includes one or more cam followers coupled to each of the pistons which remain in contact with the cam surface of one or more piston cams associated with each piston during the cycle of piston movement.

Preferably, the sleeve valve driving mechanism is a cam mechanism. More preferably, the sleeve valve cam mechanism includes one or more cam followers coupled to the at least one sleeve which remain in contact with the cam surface of one or more sleeve cams during the cycle of sleeve movement.

Preferably, the engine includes at least two sleeve valves, one sleeve valve surrounding each of the at least two pistons, the sleeve valves arranged to be reciprocated by the sleeve valve driving mechanism in an opposed manner within the same cylinder.

Preferably, the at least two sleeve valves are arranged to be reciprocated by the sleeve valve driving mechanism linearly, coaxially, and coaxially with the at least two pistons. More preferably, the at least two sleeve valves are arranged to be reciprocated by the sleeve valve driving mechanism between respective TDC positions in which the sleeve valves are substantially adjacent one another and respective BDC positions in which the sleeve valves are spaced from one another. More preferably, the at least two sleeve valves are arranged to be reciprocated by the sleeve valve driving mechanism out of phase with one another. More preferably, one of the at least two sleeve valves is arranged to control the porting of the at least one intake port and the other of the at least two sleeve valves is arranged to control the porting of the at least one exhaust port.

Preferably, a plurality of intake ports is provided through the cylinder wall at a location between the TDC and BDC positions of one of the opposed pair of reciprocatable sleeve valves and a plurality of exhaust ports is provided through the cylinder wall at a location between the TDC and BDC positions of the other of the opposed pair of reciprocatable sleeve valves. The provision of multiple ports around the circumference of the sleeve increases the effective area of the intake and exhaust ports.

Preferably, the cumulative total port area of the plurality of intake ports is about the same as, or larger than, the surface area of one of the piston crowns. Preferably, the cumulative total port area of the plurality of exhaust ports is also about the same as, or larger than, the surface area of one of the piston crowns. The total area of the intake ports and the total area of the exhaust ports is therefore considerably larger than is possible in other known engines in which the port opening and closing is controlled by the pistons. The use of a sleeve valve to cover and uncover the exhaust ports enables the pistons to travel right to the bottom of the expansion stroke before the exhaust ports are opened. This leads to a significant increase in the effective length of the expansion stroke compared to known engines in which the pistons are used to cover and uncover the exhaust ports. The use of a sleeve valve to cover and uncover the intake ports enables the intake porting to be controlled independently of the piston position and enables the intake porting to be more precisely controlled than in known engines in which the pistons are used to cover and uncover the intake ports.

Preferably, in use of the engine, the sleeve valve driving mechanism holds the at least two sleeve valves in their respective TDC positions for a greater number of degrees of shaft rotation than the number of degrees of shaft rotation during which the pistons are held in their respective TDC positions by the dwell mechanism.

Preferably, at least one of the one or more piston cams is an axial cam. Preferably, at least one of the one or more sleeve valve cams is also an axial cam. Preferably, the at least one axial piston cam for each piston is located on the at least one shaft.

Preferably, the at least one axial sleeve cam for each sleeve valve is located on the at least one shaft. The at least one axial piston cam for each piston and the at least one axial sleeve cam for each sleeve valve are integrally formed with the at least one shaft. Alternatively, the at least one axial piston cam for each piston and the at least one axial sleeve cam for each sleeve valve are splined for engagement with one or more corresponding splines on the at least one shaft. Alternatively, the axial piston cam for each piston and the axial sleeve cam for the respective sleeve are integrally formed on the same cam body, the cam body being splined for engagement with a corresponding spline on the at least one shaft.

Preferably, in use of the engine, the at least one exhaust port is opened by the at least one sleeve valve substantially as the pistons reach their respective BDC positions.

Preferably, in use of the engine, the at least one intake port is opened by the at least one sleeve valve about 20 degrees of rotation of the shaft after the pistons reach their respective BDC positions.

Preferably, in use of the engine, the at least one exhaust port is closed by the at least one sleeve valve about 30 degrees of rotation of the shaft after the pistons leave their respective BDC positions.

Preferably, in use of the engine, the at least one intake port is closed by at least one sleeve valve about 50 degrees of rotation of the shaft after the pistons leave their respective BDC positions.

Preferably, in use of the engine, the at least one intake port is closed by at least one sleeve valve about 20 degrees of shaft rotation after the exhaust port is closed so as to enable pressure charging of the air entering through the at least one intake port.

An intake tract leading to the at least one intake port may be bifurcated to allow streams of scavenging and charging air to be of separate origin, such as from a mechanical pump for scavenging air and from an exhaust turbocharger for charging air.

Preferably, the at least one shaft is an output shaft for power take-off.

The invention is suitable for use in a wide variety of applications including, but not limited to: land-based power generators; automotive applications, for example engines for use in vehicles such as cars or motorcycles, lorries, trucks, railway locomotives, earth moving equipment; marine applications, for example, outboard or onboard engines for boats; aviation applications, for example engines for use in light manned, aircraft or UAVs.

The invention is particularly suited to, but by no means limited to, a two-stroke, compression ignition, internal combustion engine. The engine is also suitable for use as a two-stroke, spark or plasma ignition, internal combustion engine, among other types of engine.

### BRIEF DESCRIPTION OF THE DRAWINGS

Some example embodiments of the present invention will now be further described, by way of example only, with reference to the accompanying drawings, in which:

FIG. 1 is a perspective view of an opposed piston engine embodying the present invention;

FIG. 2 is a perspective view from and end of the engine of FIG. 1 with an end cap or plate removed;

FIG. 3 is a perspective cutaway version of the engine of FIG. 1 showing three complete pistons, two of which are surrounded by their respective sleeves, and one sectioned piston;

FIG. 4 is a perspective view of a section through of the engine of FIG. 1 with the piston assemblies removed;

FIG. 5 is a further perspective view of a section through of the engine of FIG. 1 complete with piston assemblies;

FIG. 6 is a further perspective view of a section through the engine of FIG. 1 in a vertical plane through the longitudinal centreline of the shaft;

FIG. 7 is a further perspective view of a section through the engine of FIG. 1 in a vertical plane parallel to the plane of FIG. 6;

FIG. 8 is a side view of the section of FIG. 7 with the opposed pistons in their respective TDC positions;

FIG. 9 is a side view of the section of FIG. 7 with the opposed pistons in their respective BDC positions;

FIG. 10a is a side view of the shaft and piston and sleeve assemblies of the engine of FIG. 1;

FIG. 10b is a perspective view of the shaft and piston and sleeve assemblies of the engine of FIG. 1;

FIG. 10c is a further perspective view of the shaft and piston and sleeve assemblies of the engine of FIG. 1, about 180 degrees of shaft rotation around from the view of FIG. 10b;

FIG. 11a is a side view of the shaft and piston assemblies of the engine of FIG. 1 with the sleeve valves removed;

FIG. 11b is a perspective view of the shaft and piston assembly of the engine of FIG. 1 with the sleeve valves removed;

FIG. 11c is a further perspective view of the shaft and piston assembly of the engine of FIG. 1 with the sleeve valves removed about 180 degrees of shaft rotation around from the view of FIG. 11b;

FIGS. 12a to 12c are a series of perspective views from different angles of the shaft assembly of the engine of FIG. 1;

FIGS. 13a and 13b are perspectives view of a piston of the engine of FIG. 1

FIG. 14 is a section through the engine of FIG. 1 at a point in the engine cycle during the period of dwell of the pistons at their TDC positions;

FIG. 15 is a further section through the engine of FIG. 1 at a point in the engine cycle during the period of dwell of the pistons at their BDC positions with the intake port(s) fully covered by the intake sleeve valve and the exhaust port(s) partially uncovered by the exhaust sleeve valve;

FIG. 16 is a further section through the engine of FIG. 1 at a point in the engine cycle at which the pistons have arrived at their respective BDC positions, the exhaust port(s) is uncovered with the exhaust sleeve at or near its BDC position and the intake port(s) remains partially uncovered by the intake sleeve valve. The engine is therefore undergoing a period of blowdown;

FIG. 17 is a further section through the engine of FIG. 1 at a point in the engine cycle at which the pistons are subjected to dwell in their respective BDC positions, the exhaust port(s) is fully covered by the exhaust sleeve valve and the intake port(s) is partially uncovered with the intake sleeve valve at or near its BDC position. The engine is therefore undergoing a period of supercharging;

FIG. 18 is a further section through the engine of FIG. 1 at a point in the engine cycle during the compression stroke of the pistons with the exhaust port(s) fully covered by the exhaust sleeve valve and the intake port(s) partially uncovered by the intake sleeve valve; and

FIG. 19 is a diagram showing piston, exhaust sleeve valve and intake sleeve valve stroke position with degrees of shaft rotation during the cycle of the engine of FIG. 1.

### DETAILED DESCRIPTION OF PREFERRED EMBODIMENTS

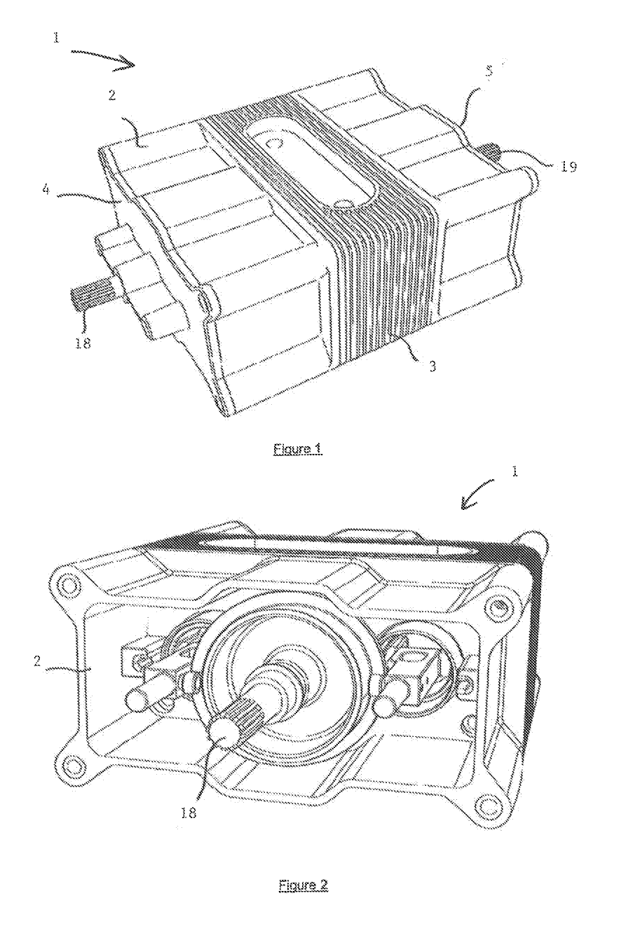

With reference to FIGS. 1 to 3, an engine 1 comprises a fixed cylinder block 2 which may be provided with conventional cooling fins 3. The cylinder block is attachable to a frame or vehicle chassis (not shown) using conventional fixing means. The cylinder block is provided with a pair of removable end caps or plates 4,5 attachable to the block with conventional fixing means to permit assembly and disassembly of the engine. The cylinder block may alternatively be formed in two halves attachable by conventional fixing means.

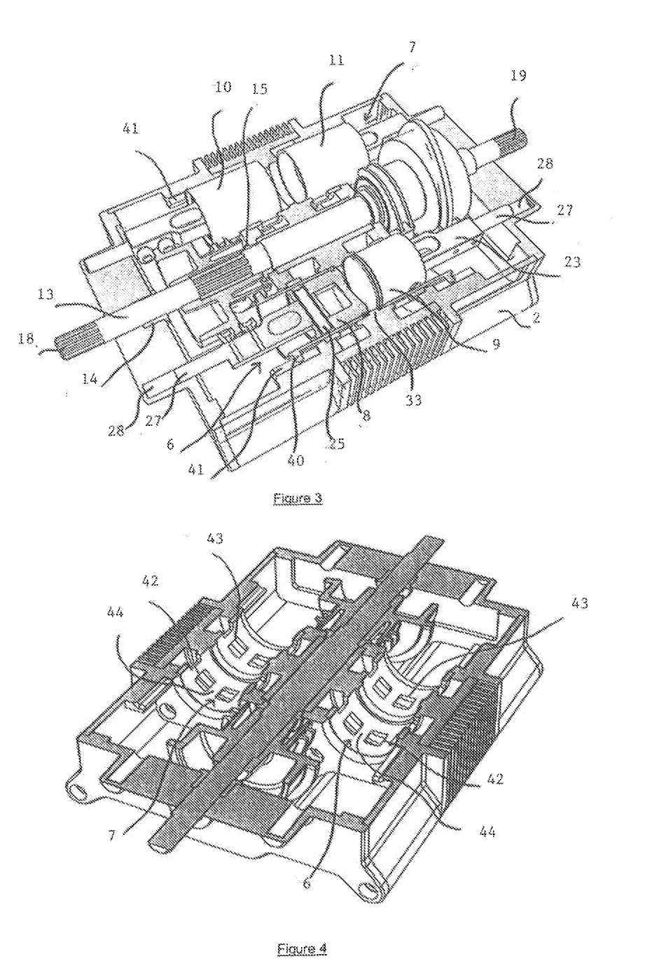

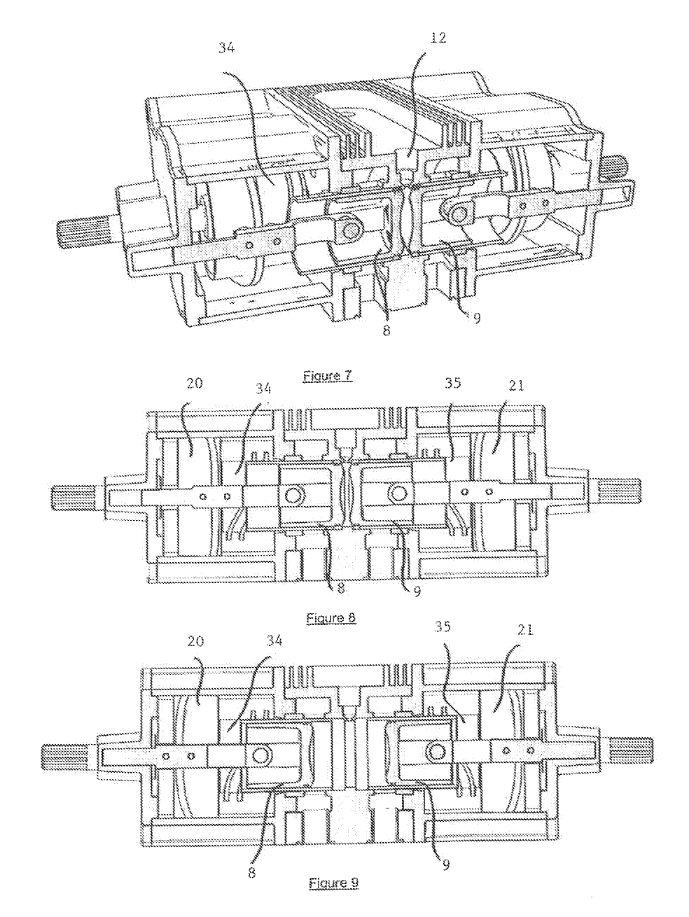

With reference to FIGS. 3 to 9, the cylinder block defines two elongate, horizontally extending, cylinders 6,7. A pair of opposed pistons 8,9 and 10,11 is arranged to be reciprocated linearly and coaxially within each of the cylinders 6,7 between respective Top Dead Centre (TDC) positions (FIG. 8) in which the piston crowns of the opposed pistons in each cylinder are substantially adjacent one another and respective Bottom Dead Centre (BDC) positions (FIG. 9) in which the piston crowns of the opposed pistons in each cylinder are spaced from one another. The pistons in each of the opposed pairs of pistons are arranged to be reciprocated synchronously and in opposite directions. One or more injectors is positionable within a port 12 for injecting fuel into the cylinder in the space between the pistons crowns of the opposed pistons. The piston crowns are preferably provided with a concave depression or bowl to provide a combustion space. The pistons may be also be provided with a squish band to promote turbulence in the combustion chamber.

A shaft 13 extends through the centre of the engine between the two cylinders. The rotational axis of the shaft is spaced from, and parallel to, the axis of reciprocation of the pistons. The shaft is rotationally supported in the cylinder block by a series of bearings 14,15,16,17. The ends 18,19 of the shaft are splined for connection to a gear or belt drive system (not shown). As will be described in more detail below, the engine is configured so that linear reciprocation of the opposed pairs of pistons within their respective cylinders resulting from the combustion of fuel/air mixture in the cylinders causes the shaft to rotate.

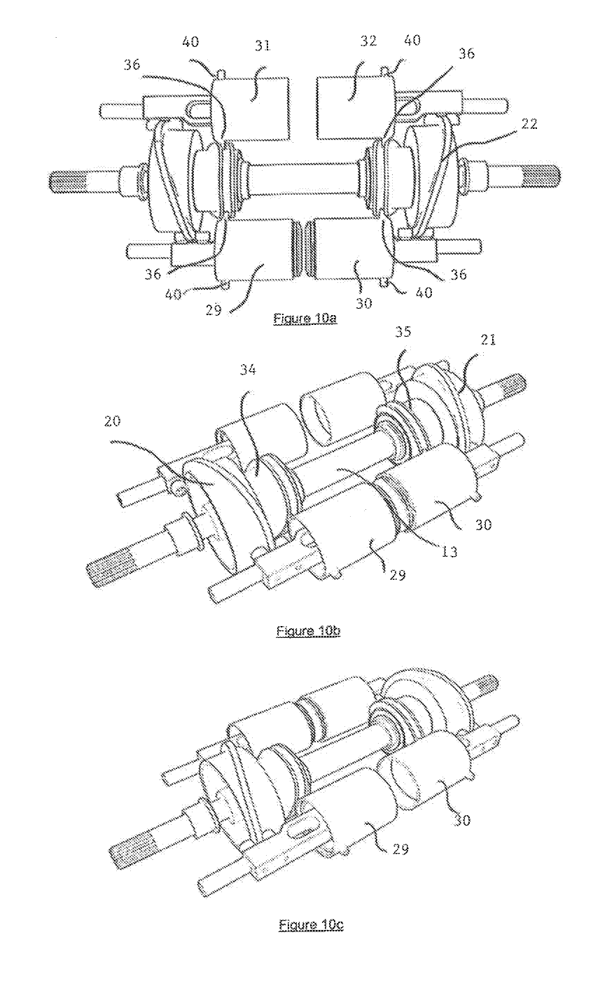

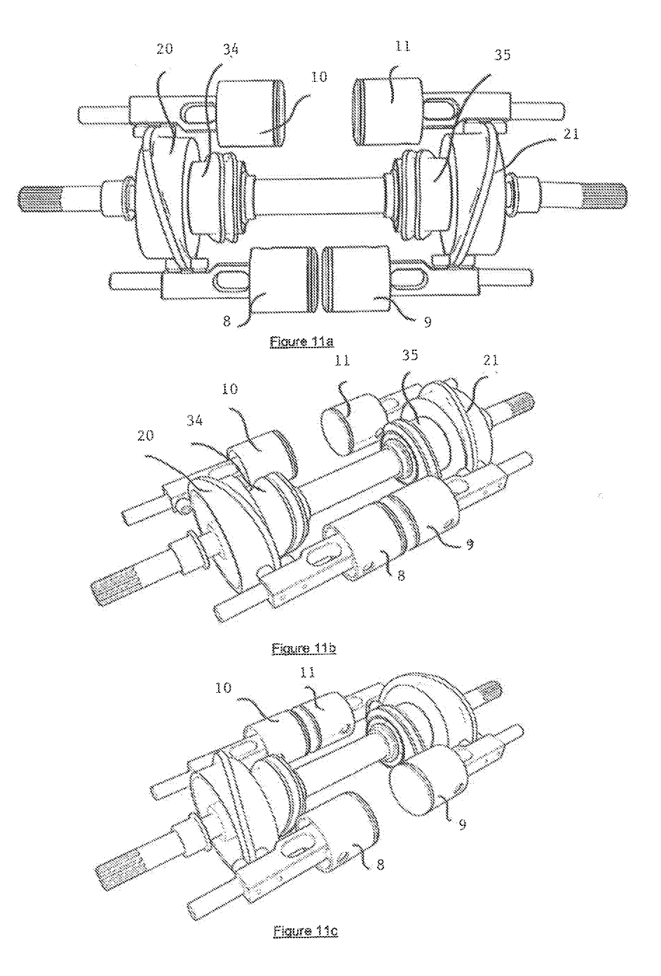

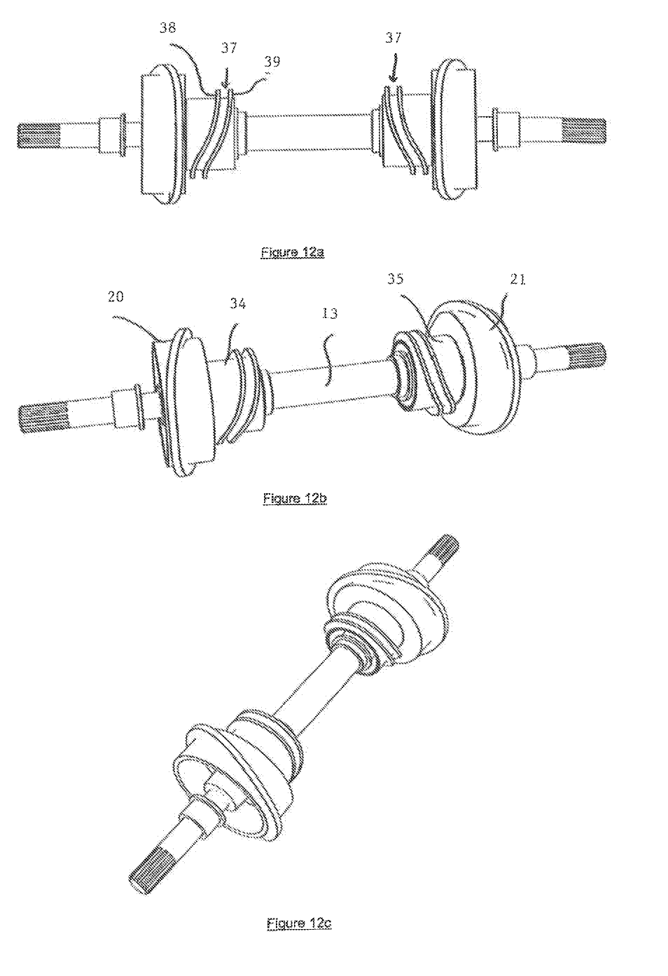

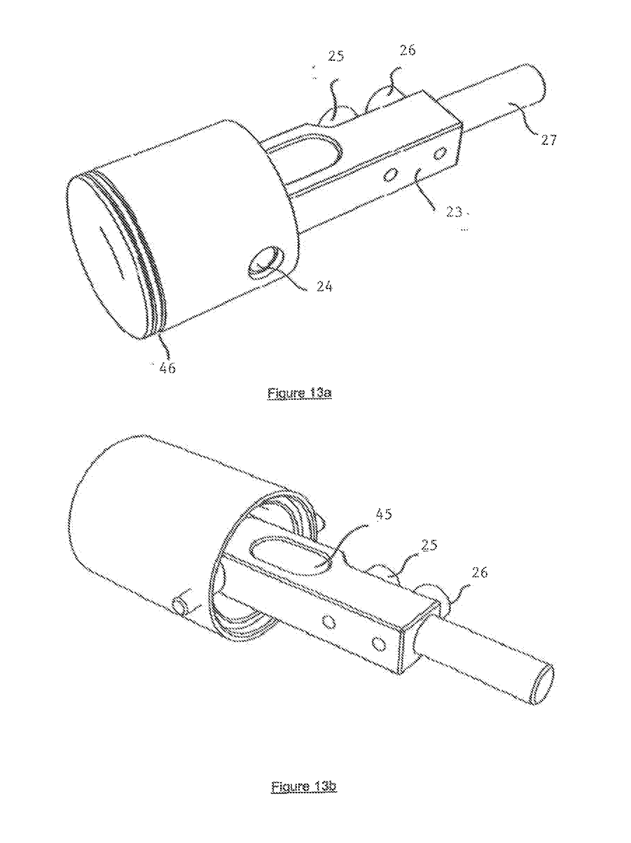

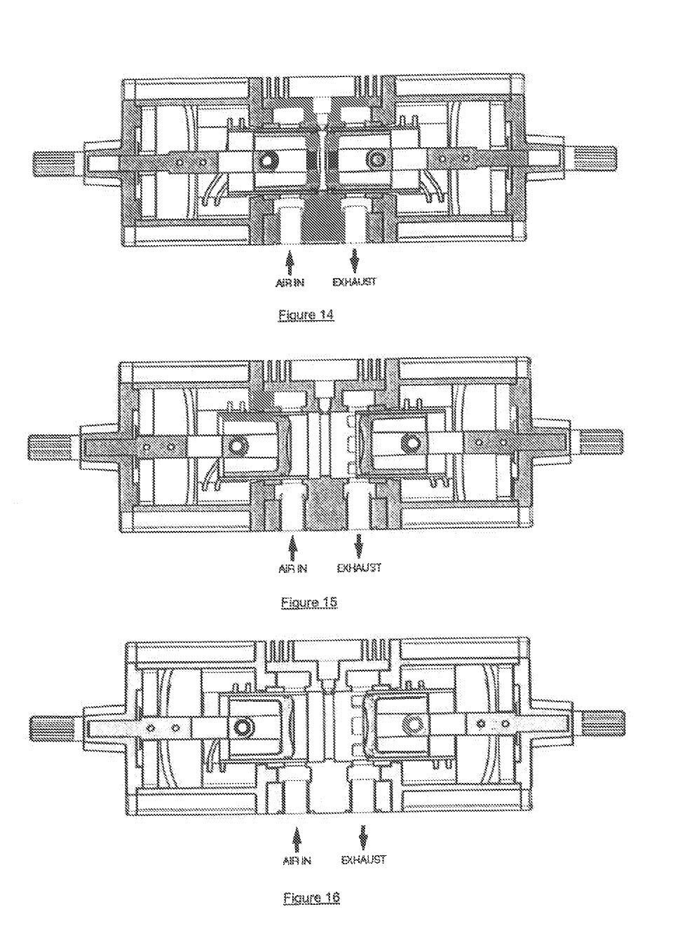

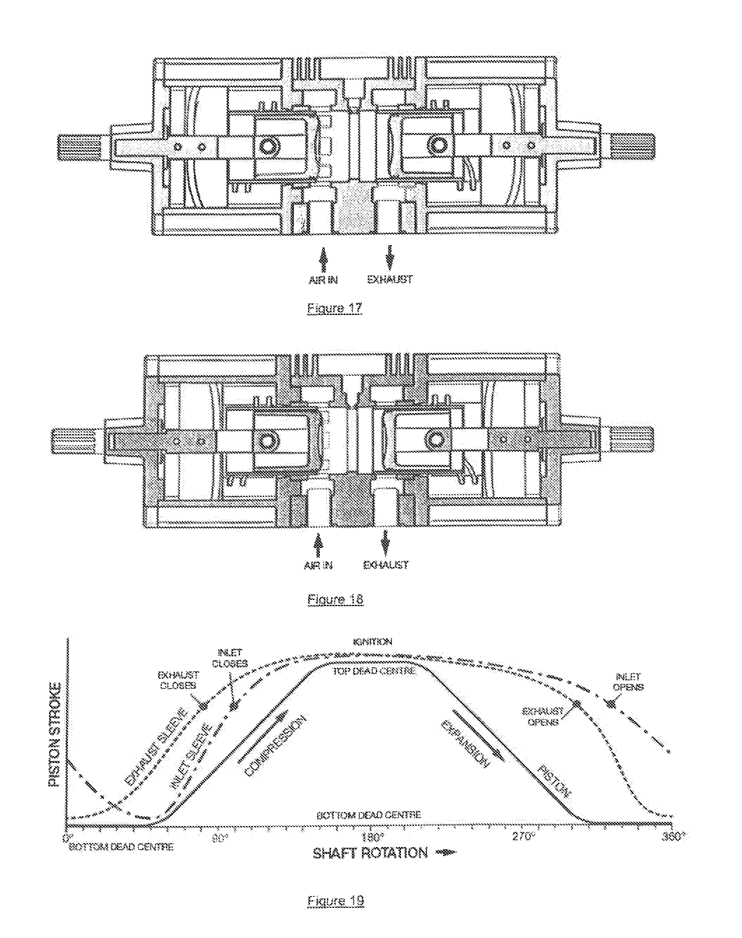

The engine includes a cam mechanism for converting linear reciprocal motion of the pistons into rotational motion of the shaft. As shown in detail in FIGS. 10a to 12c, the cam mechanism includes a pair of spaced apart axial cams 20,21 positioned on the shaft 13. The cams are positioned generally transversely adjacent to the cylinders, each one being positioned between an adjacent pair of pistons on opposite sides of the shaft.

The axial cams may be integrally formed with the shaft. Alternatively, the cams may be provided on a cam body which may be splined for engagement with corresponding splines on the shaft. The cams define a cam surface. The cam surface may formed as shown by a single projecting flange 22 projecting from the body of the cam and defining inner and outer cam surfaces. Alternatively, the cam surface may be formed by a pair of spaced, parallel, flanges projecting from the body of the cam, or a groove or channel within the body of the cam, defining inner and outer cam surfaces.

As shown in more detail in FIGS. 13a and 13b, each of the pistons 8,9,10,11 is provided with an extension portion or piston rod 23 coupled to the piston by a transverse pin or shaft 24. The piston rod is provided with a pair of followers or rollers 25,26 positioned to act on the inner and outer cam surfaces on opposite sides of the flange. Adjacent each of the cylinders, the pairs of spaced apart followers of an adjacent pair of pistons 8,10 and 9,11 on opposite sides of the shaft 13 act on the cam surfaces of the same axial cam 20,21 at diametrically opposite sides of the cam. Both pistons are thereby arranged to rotate the same cam.

Each of the piston rods may be provided with a pin 27 projecting from the outer end of the piston rod which is arranged to slide within a cylindrical slot or blind hole 28 in the end cap of the cylinder block in order. This may help to stabilise the piston and prevent rocking of the piston within the cylinder during reciprocal piston movement. The hole in the end cap and/or the pin may be lined or coated with a suitable friction reducing material.

The axial cams adjacent each end of the cylinder can be shaped during manufacture to define and control the reciprocal motion of the pistons. The axial cams may, for example, be shaped so that the opposed pistons in one of the cylinders are reciprocated out of phase with the opposed pistons in the other cylinder or so that, in each cylinder, the opposed pistons are reciprocated out of phase with each other.

The axial cams are shaped to induce at least one period of dwell of each of the pistons during their respective cycle of piston movement. In particular, the cams are shaped to provide a period of dwell of the pistons at the BDC position of the pistons. The shaft rotating mechanism may also be configured to induce a period of dwell of each of the pistons at the TDC position of the pistons. The duration of the dwell of the pistons is determined by the profile of the axial cams. The cams may, for example, be designed so as to define an appropriate dwell period for a particular application and/or to provide desired engine operating characteristics and/or to optimise the engine for operating in a particular environment and/or for using a particular type and/or quality of fuel. Where the axial cams are provided with a spline for engagement with a corresponding spline on the shaft, the engine may be modified after initial manufacture to include a different axial cam having a different cam profile defining a different period of dwell.

In the preferred embodiment, the axial cams are shaped so that the pistons are subjected to a period of dwell in their respective BDC positions while the majority, or substantially all of the scavenging of the waste products of combustion through the at least one exhaust port occurs before the pistons begin to move towards the TDC position on the compression stroke. Preferably, the piston cams 20,21 are shaped to provide a period of dwell of the pistons at TDC of between 60 and 140 degrees of shaft rotation. More preferably, the cams are shaped to provide a period of dwell of the pistons at TDC of about 100 degrees of shaft rotation.

In the preferred embodiment, the axial cams are shaped so that the pistons dwell in their respective TDC positions while substantially all of the heat exchange of combustion takes place in the cylinder at constant volume before the pistons begins to move away from their respective BDC positions on their expansion stroke. Preferably, the cams are shaped to provide a period of dwell of the pistons at BDC of between 20 and 60 degrees of shaft rotation. More preferably, the cams are shaped to provide a period of dwell of the pistons at TDC of about 40 degrees of shaft rotation.

The aforementioned preferred dwell periods have been selected to provide efficient operation of the engine and represent a balance between a wide range of relevant factors. Other dwell periods may also be suitable for the engine and may be determined by any or all of the following: a particular application (e.g. where maximum power output or fuel efficiency is critical); a particular environment (e.g. where the ambient air temperature is particularly high or low); the availability of certain types and/or qualities of fuel; and other relevant factors.

With reference to FIGS. 3 to 10c, each of the cylinders is further provided with a pair of opposed sleeve valves 29,30 and 31,32, one sleeve valve surrounding each of the opposed pistons in each cylinder. The sleeve valves in each cylinder are arranged to reciprocate in an opposed manner, coaxially with one another and coaxially with the axis of reciprocation of the opposed pistons. The sleeve valves are reciprocatable between respective TDC positions in which the sleeve valves are substantially adjacent one another and BDC positions in which the sleeve valves are spaced from one another. In their respective TDC positions, the sleeves may be positioned closer together than the pistons. In their TDC positions, the sleeves preferably abut one another so as to provide a sealed combustion chamber. The sleeves may alternatively abut a shoulder 33 protruding into the cylinder from the cylinder wall. The sleeves may be provided with flat, angled or profiled inner ends. As will be described further below, the sleeves valves are used to control porting of the engine and enable the intake and exhaust porting to be controlled independently of the position of the pistons within the cylinders.

A sleeve valve driving mechanism is provided for reciprocating the sleeves within the cylinders. The sleeve driving mechanism includes a further pair of axial cams 34,35 positioned between the cylinders. One axial cam is provided on each side of the transverse centreline of the engine, one for each transversely adjacent pair of sleeves on opposite sides of the shaft 13. The sleeve cams are positioned on the shaft, between the axial piston cams 20,21. As described above in relation to the piston cams, the sleeve cams may be integrally formed with the shaft or splined for engagement with a corresponding spline on the shaft to permit removal for repair, modification and/or replacement.

As shown in more detail in FIGS. 10a to 10c and 13a and 13b, each of the sleeve valves is provided with a pin 36 projecting transversely from the surface of the sleeve valve proximate its outer end. The axial sleeve cams define a cam track 37 for receiving the sleeve valve pins. The track may be formed by a pair of spaced apart, parallel, flanges 38,39 or by a groove or channel in the surface of the body of the cam. The cam defines inner and outer cam surfaces. The axial sleeve cams are positioned so that a sleeve pin on each of a transversely adjacent pair of sleeve valves on opposite sides of the shaft engages with diametrically opposite sides of the same cam track defined by each axial cam. The sleeve valve pins remain in constant contact with the axial cam surface as the shaft rotates.

The sleeve valves may also be provided with a further pin 40 proximate the outer end and on the diametrically opposite side of the sleeve valve to the pin which engages with the axial sleeve cams. This further pin slides along a groove or channel 41 in the cylinder block during reciprocal motion of the sleeve. This can help to stabilise the sleeve valve and prevent rocking of the sleeve valves within the cylinders. The groove or channel may be lined or coated with a suitable friction-reducing material.

As described above in relation to the axial piston cams 20,21, the axial sleeve cams 34,35 can be shaped during manufacture to define and control the reciprocal motion of the sleeve valves. They may, for example, be shaped so that the opposed sleeve valves in one of the cylinders are reciprocated out of phase with the opposed sleeve valves in the other of the cylinders or so that in each cylinder, the opposed sleeve valves are reciprocated out of phase with each other.

The sleeve driving mechanism is arranged to reciprocate each sleeve in the same direction as their respective piston but some time after movement of the piston. This may be achieved by one or both of: the shape of the axial sleeve cams; and the axial sleeve cams being positioned further around the shaft from the piston cams so that they are out of phase with the axial piston cams.

As shown in FIG. 4, intake and exhaust ports are provided through the cylinder walls. In particular, in each of the cylinders, one or more intake ports 42 is provided through the cylinder wall between the TDC and BDC positions of one of each opposed pair of pistons and one or more exhaust ports 43 is provided through the cylinder wall between the TDC and BDC positions of the other of each opposed pair of pistons. Preferably, a plurality of intake 42 and/or exhaust ports 43 is provided in each of the cylinders and the ports are evenly spaced around the circumference of the cylinders and centred on the same plane transverse to the axis of reciprocation of the pistons. The ports are spaced from one another around the circumference of the cylinders by bridge portions 44.

In each cylinder, the intake and exhaust ports are therefore spaced from one another along the length of the cylinder and positioned on opposite sides of a transverse centreline of the engine so that porting of the intake ports is controlled by one of the sleeve valves of each opposed pair of sleeve valves and porting of the exhaust ports is controlled by the other of the sleeve valves of each opposed pair of sleeve valves. The cumulative total port area of the plurality of intake ports is about the same as the area of one of the piston crowns and the cumulative total port area of the plurality of exhaust ports is about the same as the area of one of the piston crowns.

As shown in FIG. 19 and as described below in more detail, in an example form the engine designed with a particular focus on improved volumetric efficiency, the cam profile of the axial sleeve cams is shaped such that the intake and exhaust sleeves, although continuously moving along the cylinders during their cycle of motion, only move a relatively small proportion of their respective sleeve valve stroke during the period of shaft rotation which includes: (i) the compression stroke of the pistons, (ii) the period of piston dwell at TDC and (iii) the expansion stroke of the pistons. Alternatively, the cam profile of the axial sleeve cams may be shaped so that either or both of the intake and exhaust sleeves is subjected to a longer, or shorter, period of reduced linear movement or a period of dwell during the engine cycle.

The cam profile of each of the axial sleeve cams may be shaped such that any one or combination of the following apply:—

(i) in each cylinder, one or both of the intake and exhaust sleeves is subjected to a period of continuous movement which approximates dwell during the engine cycle;

(ii) in each cylinder, the intake sleeve moves about 20 percent of its sleeve valve stroke in each direction (i.e. on each side of the TDC position of the intake sleeve curve of FIG. 19) over a period of between about 150 and about 250 degrees of rotation of the shaft, preferably about 195 degrees of rotation of the shaft;

(iii) in each cylinder, the intake sleeve approximates dwell for a period of between about 80 and about 150 degrees of rotation of the shaft, preferably about 115 degrees of rotation of the shaft. This is shown by a substantially flat portion of the intake sleeve curve of FIG. 19 which extends over the TDC position of the sleeve where, for example, the intake sleeve travels only about 5 to 10 percent of its sleeve valve stroke in each direction (i.e. on each side of the TDC position of the intake sleeve valve curve);

(iv) in each cylinder, the exhaust sleeve moves about 20 percent of its sleeve valve stroke in each direction (i.e. on each side of the TDC position of the exhaust sleeve curved of FIG. 19) over a period of between about 150 and about 250 degrees of rotation of the shaft, preferably about 195 degrees of rotation of the shaft;

(v) in each cylinder, the exhaust sleeve approximates dwell for a period of between about 80 and about 150 degrees of rotation of the shaft, preferably about 110 degrees of rotation of the shaft. This is shown by a substantially flat portion of the exhaust sleeve curve of FIG. 19 which extends over the TDC position of the sleeve where, for example, the exhaust sleeve travels only about 5 to 10 percent of its sleeve valve stroke in each direction (i.e. on each side of the TDC position of the exhaust sleeve curve);

(vi) in each cylinder, the majority of the stroke of each of the intake and exhaust sleeves is traveled during the period of dwell of the pistons in their respective BDC positions;

(vii) in each cylinder, each of the inlet and exhaust sleeves remain substantially adjacent one another in their respective TDC positions so as to form a combustion chamber for a period of shaft rotation which is at least as long as and which includes, the period of shaft rotation during which the pistons dwell in their respective TDC positions.

(viii) in each cylinder, each of the inlet and exhaust sleeves remain proximate one another in their respective TDC positions so as to form a combustion chamber for a period of shaft rotation which is longer than the period of shaft rotation during which the pistons dwell in their respective TDC positions.

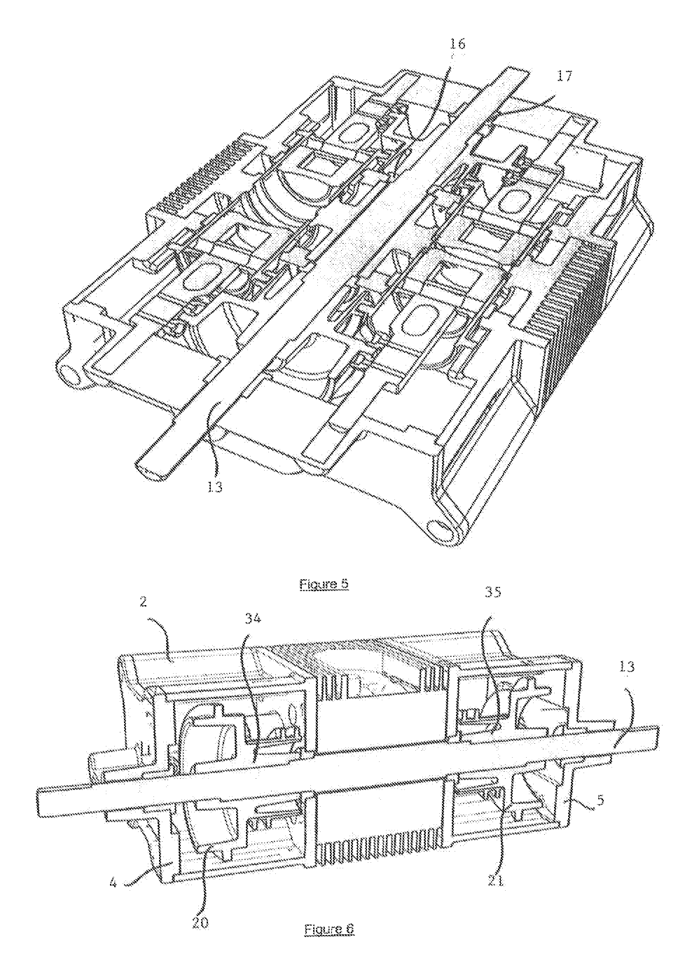

The outer ends of the axial piston cams and the axial sleeve cams may be hollowed for weight reduction (FIG. 6). Preferably, the piston rods are provided with a hole or slot 45 (FIGS. 13a and 13b) for further weight reduction.

The cylinder block may, for example, be made from Aluminium alloy or cast iron. The pistons may, for example, be made from a high silicon, low expansion, piston alloy. The sleeves may, for example, be made from hardened and ground steel, coated aluminium alloy, or hard plated bronze. The shaft may, for example, be made from high tensile steel. The axial piston and sleeve cams may, for example, be made from hardened steel or chilled cast iron.

The engine may be scavenged by compressed air only, fuel being injected after the exhaust ports are closed by the exhaust sleeve valves. This may be achieved by means of an exhaust turbo-compressor alone, or combined with a separate scavenging pump.

A split or bifurcated intake tract (not shown) may be provided whereby scavenging air for forcing the waste products of combustion from the cylinder through the exhaust ports may be supplied from one source and fresh charging air for the next combustion event in the cylinders may be provided from an alternative source. Pressurised scavenging air may, for example, be provided from a pressurised storage reservoir or directly from an electrically or mechanically driven pump or compressor. Pressurised charging air may be provided by means of a pressurised storage reservoir exhaust-driven turbocharger or similar device to increase the flow rate of air into the cylinders. By utilising an exhaust pressure driven compressor to provide charge compression, excess exhaust energy may be converted to useful work and the requirement for the piston to do all the work of charge compression is reduced, resulting in improved engine efficiency.

One or more fuel injectors are positioned around each cylinder through ports for injecting fuel into the combustion space. The duration of the fuel injection events can be accurately controlled and varied depending on factors such as engine speed and the load on the engine. This can be done using an electronically-controlled common rail fuel system. Fuel injection may be accomplished, for example, by means of the patented “Orbital” injection system.

It may be beneficial to inject one or more of fuel, water, methanol or diesel at an appropriate point during the engine cycle to control the combustion process. It may also be beneficial to inject additional fuel during, or just after, the period of dwell of the pistons in their TDC positions so that fuel continues to be burnt during the expansion stroke of the piston.

Ignition may be achieved by means of Homogeneous Charge Compression Ignition (HCCI) or “Smartplugs”, (a plasma injection device). Both of these allow for ultra-lean mixtures to be burned.

A sump (not shown) is provided for storing lubricating oil. Oil is circulated by a pump through oil passageways within the cylinder block and appropriate drillings in the shaft in order to lubricate the various rotating components of the engine. Lubrication of the sleeve is achieved by pressure lubrication from oil feed holes in the engine block casing mating with fine grooves machined on the outside walls of the cylinder liner.

The pistons are provided with pistons rings 46 (FIG. 13b) to provide a seal between each seal and its respective sleeve. Each reciprocating sleeve is sealed against compression by means of the inherent flexibility of its relatively thin wall.

The engine may be air cooled. Alternatively, internal passageways may be provided in the cylinder block through which a coolant is circulated by a coolant pump.

The engine may have other conventional components and systems that are not shown in the Figures, for example, any or all of the following may be provided: a starter motor and flywheel assembly; an oil sump and oil circulation system; a high pressure fuel system; an air intake and filtering system; induction manifold(s) for directing air to the cylinders; exhaust manifold(s) for removing the waste products of combustion from the cylinders; an exhaust pipe with silencer for releasing the waste products of combustion to the atmosphere; a drive for a turbocharger or supercharger; an ignition system where the engine relates to a spark ignition engine.

In operation of the engine described above with reference to the Figures, fuel is injected by the injector(s) in the first of the cylinders 6 to the combustion space defined by the sleeve valves 29,30 and the opposed piston crowns. Combustion of the fuel in the cylinder occurs at the TDC of the pistons and during a period of piston dwell of about 40 degrees of shaft rotation so that flame propagation through the fuel/air mixture in the combustion chamber occurs during the period of piston dwell at TDC. The effect of this is that all or substantially all of the heat exchange of combustion occurs at TDC constant volume.

At the end of the period of TDC dwell of the pistons, the pistons 8,9 in the first cylinder 6 begin to move outwardly along their expansion stroke towards their respective BDC positions. Movement of the pistons along the first cylinder causes movement of the associated piston rods 23 and the followers 25,26 on the piston rods engage with the cam surfaces of the axial piston cams to cause rotary motion of the axial piston cams. Rotary motion of the axial piston cams begins to rotate the shaft 13 and imparts reciprocal motion to the opposed pistons 10,11 in the second cylinder 7 causing them to move inwardly in the opposite direction to the pistons in the first cylinder along their compression stroke towards their TDC positions.

Rotary motion of the shaft also causes rotary motion of the axial sleeve valve cams 34,35 which imparts linear motion to the sleeve valves 29,30 via the pins at the inner end of the sleeves valve acting as followers. Linear motion of the sleeves controls porting of the intake and exhaust ports as discussed further below.

As the pistons 8,9 in the first cylinder 6 reach their respective BDC positions at the end of the expansion stroke, about 110 degrees of shaft rotation after the pistons began to move from their TDC position, the pistons are subjected by the axial cams of the dwell mechanism to a further period of dwell in their BDC position of about 100 degrees of shaft rotation. The pistons 10,11 in the second cylinder 7 also reach their respective TDC positions at the end of their compression stroke. During this period of dwell of the pistons in the second cylinder at BDC, the waste products of combustion are scavenged from the cylinder through the exhaust ports 43 which have been opened by the exhaust sleeve.

At the end of the period of piston dwell at BDC, the pistons 8,9 in the first cylinder 6 are advanced on their expansion stroke towards their respective TDC positions along the compression stroke by the axial cams being driven by the pistons in the second cylinder 7 along their expansion stroke. Porting of the intake 42 and exhaust 43 ports is again controlled by motion of the sleeve valves induced by rotary motion of the shaft. Air enters the cylinder through the intake port(s) 42 and is compressed between the opposed piston crowns as the pistons are advanced by the axial piston cams to their respective TDC positions about 110 degrees of shaft rotation after beginning their compression stroke. The engine cycle then repeats.

FIGS. 14 to 19 show the effect of reciprocation of the sleeve valves on the engine porting. In the FIG. 14 position, the pistons 8,9 in the first cylinder 6 are both in their TDC position at the midpoint of the dwell period. Their respective sleeves 29,30 are at or very close to their TDC position in which they abut each other or a shoulder in the cylinder wall so as to define the combustion chamber. The intake 42 and exhaust 43 ports in the cylinder walls both remain closed by the respective intake 29 and exhaust 30 sleeves. In this position, air cannot enter the cylinder and the combustion products cannot leave the cylinder and combustion of the fuel/air mixture therefore occurs at constant volume.

After the period of dwell of the pistons of about 40 degrees of shaft rotation, the pistons set off along their expansion stroke towards their respective BDC positions. The profiles of the axial piston cams and the axial sleeve cams and their relative positions on the shaft are such that there is a time lag between movement of the pistons along their expansion stroke and corresponding movement of the intake and exhaust sleeves. As shown in FIG. 19, the timing of the piston and sleeve movement is such that the exhaust sleeve begins to open the exhaust ports substantially as the pistons arrive at BDC and the exhaust sleeve accelerates rapidly so the exhaust port 43 is fully uncovered by the exhaust sleeve 30 shortly after the pistons arrive at BDC and early in BDC piston dwell period of about 130 degrees of shaft rotation. The timing of the intake sleeve movement is such that the intake sleeve 29 accelerates more slowly than the exhaust sleeve 30 and at a similar rate to the pistons 8,9 as it moves towards its BDC position. The intake sleeve arrives at its BDC position substantially as the pistons begin to move away from their BDC positions on their compression stroke.

In the FIG. 15 position, the pistons in one of the cylinders are both in their respective BDC positions and at, or near, the midpoint of their BDC dwell period. The exhaust sleeve has moved away from its TDC position towards its BDC position so as to partially uncover the exhaust ports and allow scavenging of the combustion products from the engine. The axial sleeve cams are configured so that movement of the intake sleeve is out of phase with movement of the exhaust sleeve and there is a time lag between movement of the exhaust and intake sleeves. The intake sleeve has begun to move away from its TDC position towards its BDC position but has not travelled as far along the cylinder as the exhaust sleeve. The inner edge of the intake sleeve has not yet passed the inner edge of the intake ports and so the intake ports remain fully closed.

In the FIG. 16 position, the pistons in one of the cylinders remain in their respective BDC positions during the period of dwell of the pistons. The exhaust sleeve has reached its BDC position, uncovering the exhaust ports and allowing further scavenging of the combustion products from the engine. About 20 degrees of shaft rotation after the exhaust sleeve begun to uncover the exhaust valves, the intake sleeve has partially uncovered the intake ports allowing air to enter the cylinder. Air entering the cylinder under pressure assists with the scavenging process by forcing the combustion products through the exhaust port.

In the FIG. 17 position, the pistons in the first cylinder are about to set off along their compression stroke towards their respective TDC positions. The intake sleeve is at its BDC position and also about to set off towards its TDC position so as to cover the intake ports. The exhaust sleeve is moving from the BDC position of FIG. 16 towards the TDC position to cover the exhaust ports. Air entering the cylinder continues to assist with scavenging of the waste products from the cylinder.

In the FIG. 18 position, the pistons in the first cylinder continue to move along their compression stroke towards their TDC positions. About 30 degrees of shaft rotation after the pistons leave their TDC positions, the exhaust sleeve has fully closed the exhaust port. The intake sleeve has begun to close the intake ports but the intake ports are still partially open. Therefore, compressed air is still entering the cylinder but is no longer replacing the combustion products leaving the cylinder as the exhaust port has been closed. The compressed air entering the cylinder is compressed between the opposed piston crowns as the pistons move towards their respective TDC positions. About 20 degrees of shaft rotation after the exhaust sleeve closes the exhaust ports, the intake ports are fully closed by the intake sleeve.

The intake 29 and exhaust 30 sleeves accelerate past their respective pistons as the pistons advance towards TDC so that the sleeves arrive at their TDC positions to define and seal the combustion chamber shortly before the pistons arrive at TDC as shown in FIG. 14.

It will be appreciated from the foregoing and with particular reference to FIG. 19, that the majority of the reciprocal movement of the exhaust sleeve valve and the intake sleeve valve occurs during the period of dwell of the pistons in their BDC positions and that only a relatively small proportion of the linear reciprocal movement of the intake and exhaust sleeve valves is covered during the period of shaft rotation made up of the second half of the piston movement on the compression stroke, the piston dwell period at TDC and the first half of the piston movement on the expansion stroke.

The axial cam profiles of the cams which drive the intake and exhaust sleeve valves is likely to be a balance between the period of shaft rotation during which the inlet and/or exhaust sleeve dwells or is subject to a period of reduced linear motion, approximating dwell, and the peak acceleration of the sleeves in moving between their respective TDC and BDC positions.

By timing the exhaust sleeve valve to uncover the exhaust ports as, or just before, the pistons arrive at BDC, the pistons undergo a complete expansion stroke before the exhaust ports are uncovered and the combustion products start to be vented from the cylinder. This improves the efficiency of known engines in which the exhaust ports are uncovered early by the pistons on their expansion stroke.

By timing the exhaust sleeve to fully cover the exhaust ports during the compression stroke of the pistons after the BDC piston dwell period, the exhaust ports remain open for the entirety of the piston dwell period at BDC providing significantly more time for scavenging of the combustion products than in known engines in which there is no dwell of the pistons.

By timing the exhaust sleeve to begin to uncover the exhaust ports about 20 degrees of shaft rotation before the intake sleeve starts to uncover the exhaust ports, a period of the engine cycle is provided for blowdown to occur to allow the cylinder pressure to drop below the scavenging air pressure.

By timing the intake sleeve valve to uncover the intake ports during the early stages of the piston dwell period at BDC and to fully cover the intake ports during the compression stroke of the pistons, the intake ports remain open for a significant proportion of the engine cycle allowing time for complete charging of the cylinder before the intake ports are closed.

By timing the intake sleeve to fully cover the intake ports about 20 degrees of shaft rotation after the exhaust sleeve fully covers the exhaust ports, the engine allows for a period charge compression or ‘supercharging’ of the air entering the cylinder.

The axial sleeve cams are shaped so that the exhaust ports remain at least partially open for about 140 degrees of rotation of the shaft and the intake ports remain at least partially open for about 140 degrees of rotation of the shaft. As such, the intake and exhaust ports remain at least partially open for a substantial portion of the engine cycle.

The axial sleeve cams are also shaped so that the exhaust ports and the intake ports are both at least partially open for an overlapping period of about 120 degrees of rotation of the shaft. As such, over a substantial portion of the engine cycle, air entering the cylinder assists with scavenging of the cylinder, enhancing the flow of air through the engine.

All numeric values in the preceding description are provided by way of example only and are not intended to limit the scope of the claims. The example values of shaft rotation in the preceding description relate to one particular form of the invention designed primarily for optimum volumetric efficiency. The skilled person will readily appreciate that alternative values of shaft rotation will be appropriate for a modified version of the engine designed with one or more other key factors in mind, for example, maximum power density, operation using fuels of a particular type or grade, among others.

1. An opposed piston engine comprising:
at least one cylinder;
at least two pistons arranged to be reciprocated within the same cylinder in an opposed manner;
at least one intake port through the cylinder wall;
at least one exhaust port through the cylinder wall;
at least one shaft arranged to be rotated by reciprocal motion of the opposed pistons;
at least one linear reciprocatable sleeve valve positioned within the cylinder and surrounding at least one of the at least two pistons;
a sleeve valve driving mechanism for controlling linear reciprocal motion of the at least one sleeve valve so as to control porting of one or both of the at least one intake port and the at least one exhaust port; and
a dwell mechanism;
wherein the dwell mechanism is configured to induce at least one period of dwell of the at least two pistons during their respective cycles of piston motion.

2. An opposed piston engine according to claim 1, wherein the at least two pistons are arranged to be reciprocated linearly and coaxially.

3. An opposed piston engine according to claim 1 or 2, wherein the at least two pistons are arranged to be reciprocated between respective TDC positions in which the piston crowns are substantially adjacent one another and respective BDC positions in which the piston crowns are spaced from one another.

4. An opposed piston engine according to any of claims 1 to 3, wherein the at least two pistons are arranged to be reciprocated in a synchronous manner.

5. An opposed piston engine according to any of the preceding claims, wherein the timing of porting events during the engine cycle is controllable independently of the position of the pair of opposed pistons within the cylinder.

6. An opposed piston engine according to according to any of the preceding claims, arranged so that the reciprocal motion of the at least one sleeve valve controlled by the sleeve valve driving mechanism is linked to the reciprocal motion of the at least two pistons.

7. An opposed piston engine according to claim 6, wherein the sleeve valve driving mechanism is arranged to reciprocate the at least one sleeve valve out of phase with the reciprocal motion of the at least two pistons.

8. An opposed piston engine according to any of the preceding claims, wherein the dwell mechanism is configured to induce a period of dwell of the pistons at their respective BDC positions during the cycle of piston motion.

9. An opposed piston engine according to claim 8, wherein the period of dwell of the pistons at their respective BDC positions is sufficient for the majority of scavenging of the waste products of combustion through the at least one exhaust port to occur before the pistons begin to move away from their respective BDC positions.

10. An opposed piston engine according to claim 8 or 9, wherein the dwell mechanism is configured to induce a period of dwell of the pistons at their respective BDC positions of between 60 and 140 degrees of rotation of the at least one shaft.

11. An opposed piston engine according to any of claims 8 to 10, wherein the dwell mechanism is configured to induce a period of dwell of the pistons at their respective BDC positions of about 100 degrees of rotation of the at least one shaft.

12. An opposed piston engine according to any of the preceding claims, wherein the dwell mechanism is configured to induce a period of dwell of the pistons at their respective TDC positions during the cycle of reciprocal piston motion.

13. An opposed piston engine according to claim 12, wherein the period of the pistons at their respective TDC positions is sufficient for substantially all of the heat exchange of combustion to take place in the cylinder at constant volume before the pistons begins to move away from their respective TDC positions.

14. An opposed piston engine according to claim 12 or 13, wherein the dwell mechanism is configured to induce a period of dwell of the pistons at their respective TDC positions of between 20 and 60 degrees of rotation of the at least one shaft.

15. An opposed piston engine according to any of claims 12 to 14, wherein the dwell mechanism is configured to induce a period of dwell of the pistons at their respective TDC positions of about 40 degrees of rotation of the at least one shaft.

16. An opposed piston engine according to any of the preceding claims, wherein the dwell mechanism is a cam mechanism.

17. An opposed piston engine according to claim 17, wherein the piston cam mechanism includes one or more piston cams for each piston and one or more cam followers coupled to each of the pistons which remain in contact with the cam surface of the respective one or more piston cams for each piston during the cycle of piston movement.

18. An opposed piston engine according to any of the preceding claims wherein the sleeve valve driving mechanism is a cam mechanism.

19. An opposed piston engine according to claim 18, wherein the sleeve valve cam mechanism includes one or more sleeve cams for each of the at least one sleeve valve and one or more cam followers coupled to the at least one sleeve valve which remain in contact with the cam surface of the respective one or more sleeve cams for each of the at least one sleeve valve during the cycle of sleeve movement.

20. An opposed piston engine according to any of the preceding claims, including at least two sleeve valves, one sleeve valve surrounding each of the at least two pistons, the sleeve valves arranged to be reciprocated by the sleeve valve driving mechanism in an opposed manner within the same cylinder.

21. An opposed piston engine according to claim 20, wherein the at least two sleeve valves are arranged to be reciprocated by the sleeve valve driving mechanism linearly, coaxially, and coaxially with the at least two pistons.

22. An opposed piston engine according to claim 20 or 21, wherein the at least two sleeve valves are arranged to be reciprocated by the sleeve valve driving mechanism between respective TDC positions in which the sleeve valves are substantially adjacent one another and respective BDC positions in which the sleeve valves are spaced from one another.

23. An opposed piston engine according to any of claims 20 to 22, wherein the at least two sleeve valves are arranged to be reciprocated by the sleeve valve driving mechanism out of phase with one another.

24. An opposed piston engine according to any of claims 20 to 23, wherein a first one of the at least two sleeve valves is arranged to control the porting of the at least one intake port and a second one of the at least two sleeve valves is arranged to control the porting of the at least one exhaust port.

25. An opposed piston engine according to 24, wherein a plurality of intake ports is provided through the cylinder wall at a location between the TDC and BDC positions of the first sleeve valve reciprocatable sleeve valves and a plurality of exhaust ports is provided through the cylinder wall at a location between the TDC and BDC positions of the second sleeve valve.

26. An opposed piston engine according to claim 25, configured so that, in use, the sleeve valve driving mechanism holds the at least two sleeve valves in their respective TDC positions for a greater number of degrees of shaft rotation than the number of degrees of shaft rotation during which the pistons are held in their respective TDC positions by the dwell mechanism.

27. An opposed piston engine according to any of claims 17 to 26, wherein at least one of the one or more piston cams is an axial cam.

28. An opposed piston engine according to any of claims 19 to 27, wherein at least one of the one or more sleeve valve cams is an axial cam.

29. An opposed piston engine according to claim 27 or 28, wherein the at least one axial piston cam for each piston is located on the at least one shaft.

30. An opposed piston engine according to claim 28 or 29, wherein the at least one axial sleeve cam for each sleeve valve is located on the at least one shaft.

31. An opposed piston engine according to any of claims 27 to 30, wherein the at least one axial piston cam for each piston and the at least one axial sleeve cam for each sleeve valve are integrally formed with the at least one shaft.

32. An opposed piston engine according to any of claims 27 to 30, wherein the at least one axial piston cam for each piston and the at least one axial sleeve cam for each sleeve valve are splined for engagement with one or more corresponding splines on the at least one shaft.

33. An opposed piston engine according to any of claims 27 to 30, wherein the axial piston cam for each piston and the axial sleeve cam for the respective sleeve are integrally formed on the same cam body, the cam body being splined for engagement with a corresponding spline on the at least one shaft.

34. An opposed piston engine according to any of claims 20 to 33, configured so that in use, the at least one exhaust port is opened by the second sleeve valve substantially as the pistons reach their respective BDC positions.

35. An opposed piston engine according to any of claims 20 to 34, configured so that in use, the at least one intake port is opened by the first sleeve valve about 20 degrees of rotation of the shaft after the pistons reach their respective BDC positions.

36. An opposed piston engine according to any of claims 20 to 35, configured so that in use, the at least one exhaust port is closed by the second sleeve valve about 30 degrees of rotation of the shaft after the pistons leave their respective BDC positions.

37. An opposed piston engine according to any of claims 20 to 3, configured so that in use, the at least one intake port is closed by the first sleeve valve about 50 degrees of rotation of the shaft after the pistons leave their respective BDC positions.

38. An opposed piston engine according to any of claims 20 to 37, configured so that in use, the at least one intake port is closed by the first sleeve valve about 20 degrees of shaft rotation after the exhaust port is closed so as to enable pressure charging of the air entering through the at least one intake port.

39. An opposed piston engine according to any of the preceding claims, wherein an intake tract leading to the at least one intake port is bifurcated to allow streams of scavenging and charging air to be of separate origin, such as from a mechanical pump for scavenging air and from an exhaust turbocharger for charging air.

40. An opposed piston engine according to any of the preceding claims, wherein the at least one shaft is an output shaft for power take-off.

41. An opposed piston engine according to any of the preceding claims, wherein the engine operates a two stroke cycle.

42. An opposed piston engine according to any of the preceding claims, wherein the engine is a compression ignition engine.

43. An opposed piston engine substantially as hereinbefore described with reference to the accompanying drawings.
